(19) United States
(12) Patent Application Publication
(10) Pub. No.: US 2005/0075865 A1
(43) Pub. Date: Apr. 7, 2005

(54) Speech recognition

(76) Inventor: Ezra J. Rapoport, New York, NY (US)

Correspondence Address: FISH & RICHARDSON PC, 225 FRANKLIN ST, BOSTON, MA, 02110, US

(21) Appl. No.: 10/679,954

(22) Filed: Oct. 6, 2003

(51) Int. Cl. G10L 15/26

(52) U.S. Cl. 704/207

(57) ABSTRACT

A method of speech recognition includes determining principal components of received speech over a series of pitch periods and comparing the principal components of the received speech to stored principal components to find a set of the stored principal components that have a specified degree of similarity to the determined principal components of the received speech. The method may include determining the pitch period of the received speech. The method may include sending a signal based on comparing the principal components of the received speech to stored principal components.

### BACKGROUND

This invention relates to speech recognition. Speech recognition is the identification of spoken words by a machine such as a computer. Typically, the spoken words are analyzed by phonemes. Phonemes are digitized and matched against a database in order to identify the spoken words or the identity of a speaker.

### SUMMARY

Quasi-periodic waveforms can be found in many areas of the natural sciences. Quasi-periodic waveforms are observed in data ranging from heartbeats to population statistics, and from nerve impulses to weather patterns. The “patterns” in the data are relatively easy to recognize. For example, nearly everyone recognizes the signature waveform of a series of heartbeats. However, programming computers to recognize these quasi-periodic patterns is difficult because the data are not patterns in the strictest sense because each quasi-periodic data pattern recurs in a slightly different form from iteration to iteration. The slight pattern variation from one period to the next is characteristic of “imperfect” natural systems. It is, for example, what makes human speech sound distinctly human. The inability of computers to efficiently recognize quasi-periodicity is a significant impediment to the analysis and storage of data from natural systems. Many standard methods require such data to be stored verbatim, which requires large amounts of storage space.

In one aspect, the invention is a method for speech recognition. The method includes determining principal components of received speech over a series of pitch periods and comparing the principal components of the received speech to stored principal components to find a set of the stored principal components that have a specified degree of similarity to the determined principal components of the received speech.

In another aspect the invention is an apparatus. The apparatus includes a memory that stores executable instructions for speech recognition and a processor. The processor executes instructions to determine principal components of received speech over a series of pitch periods and to compare the principal components of the received speech to stored principal components to find a set of the stored principal components that have a specified degree of similarity to the determined principal components of the received speech.

In still another aspect, the invention is an article that includes a machine-readable medium that stores executable instructions for speech recognition. The instructions cause a machine to determine principal components of received speech over a series of pitch periods and to compare the principal components of the received speech to stored principal components to find a set of the stored principal components having a specified degree of similarity to the determined principal components of the received speech.

By using principal component analysis approach for providing speech recognition, less speech pattern data is required to be stored resulting in less storage space. Also, using less speech pattern data to perform comparisons, reduces the processing time that is required to recognize a speech pattern.

### DESCRIPTION OF THE DRAWINGS

FIG. 1 is a block diagram of a speech recognition system.

FIG. 2 is a flowchart of a process for speech recognition.

FIG. 3 is a flowchart of a process to determine pitch periods.

FIG. 4 is an input waveform showing the relationship between vector length, buffer length and pitch periods.

FIG. 5 is an amplitude versus time plot of a sampled waveform over a pitch period.

FIGS. 6A-6C are plots representing a relationship between data and principal components.

FIG. 7 is a flowchart of a process to determine principal components.

FIG. 8 is a plot of an eigenspectrum for a phoneme.

FIG. 9 is a block diagram of a computer system on which the process of FIG. 2 may be implemented.

### DESCRIPTION

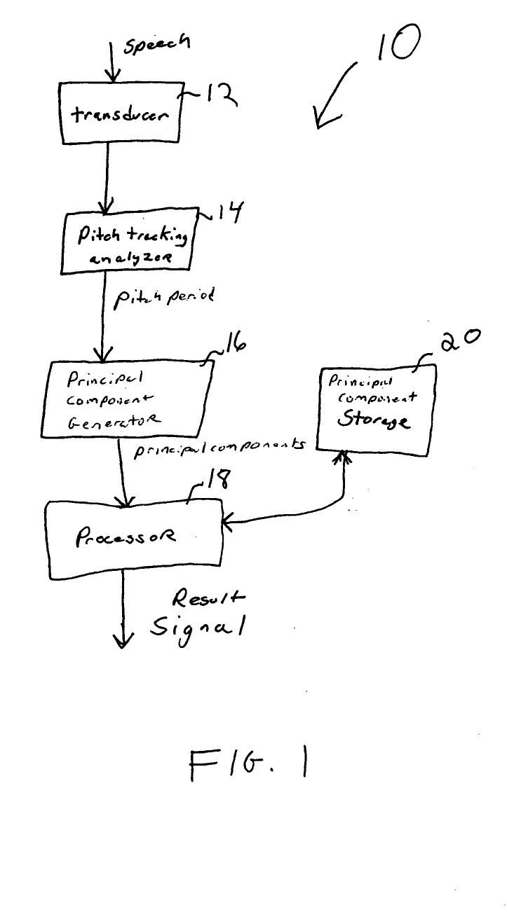

Referring to FIG. 1, a speech recognition system 10 includes a transducer 12 that receives speech, a pitch track analyzer 14, a principal component generator 16, a processor 18 and a principal component storage device 20 that stores principal components. The principal components apply to a wide-range of speakers for a given set of words. Each word has a range of principal components that correspond to a word. For example, the principal components for each word includes principal components from 95% of the speakers centered on a normal bell-shaped Gaussian distribution. The principal components are stored empirically by having a sample of the population reading the given set of words and then storing a range of the principal components for each word in principal component storage device 20.

In some embodiments, a range of principal components are stored by phonemes (unit of speech) instead of by words.

Principal component analysis (PCA) is a linear algebraic transform. PCA is used to determine the most efficient orthogonal basis for a given set of data. When determining the most efficient axes, or principal components of a set of data using PCA, a strength (i.e., an importance value called herein as a coefficient) is assigned to each principal component of the data set.

The pitch track analyzer 14 analyzes the pitch periods of an input waveform (e.g., a speech signal). Principal component generator 16 calculates the principal components for the initial pitch period received. Principal component generator 16 sends the first 6 principal components to processor 18. Processor 18 compares the principal components in principal component storage 20 with the principal components generated by PCA generator 16 and outputs a signal as a result of the comparison. The output can be a phoneme that is rendered as audible speech from a transducer, or it can be text that is produced from a text generator based on the phoneme.

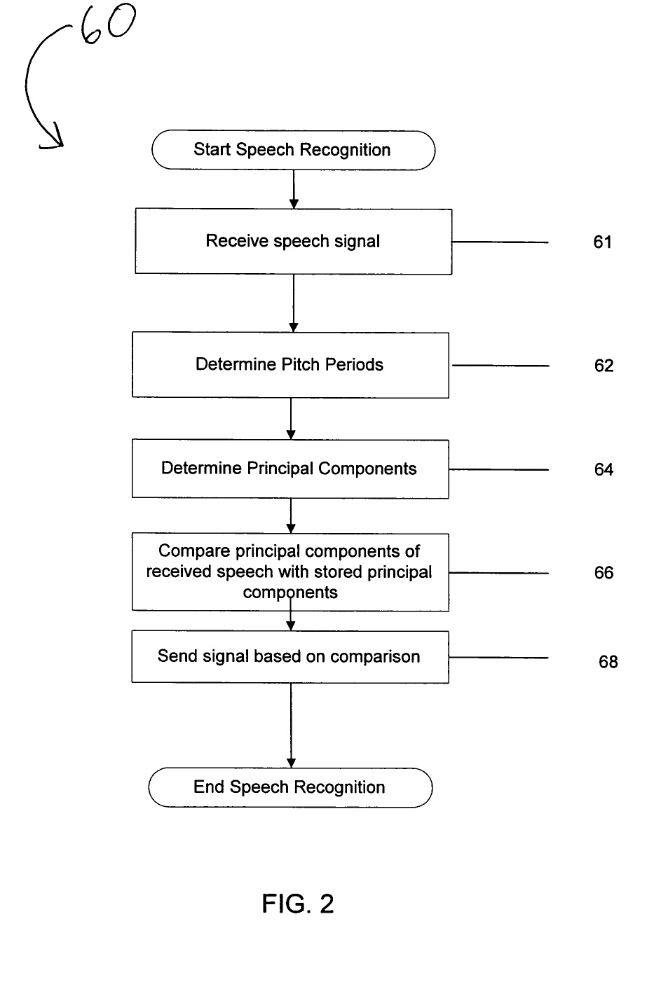

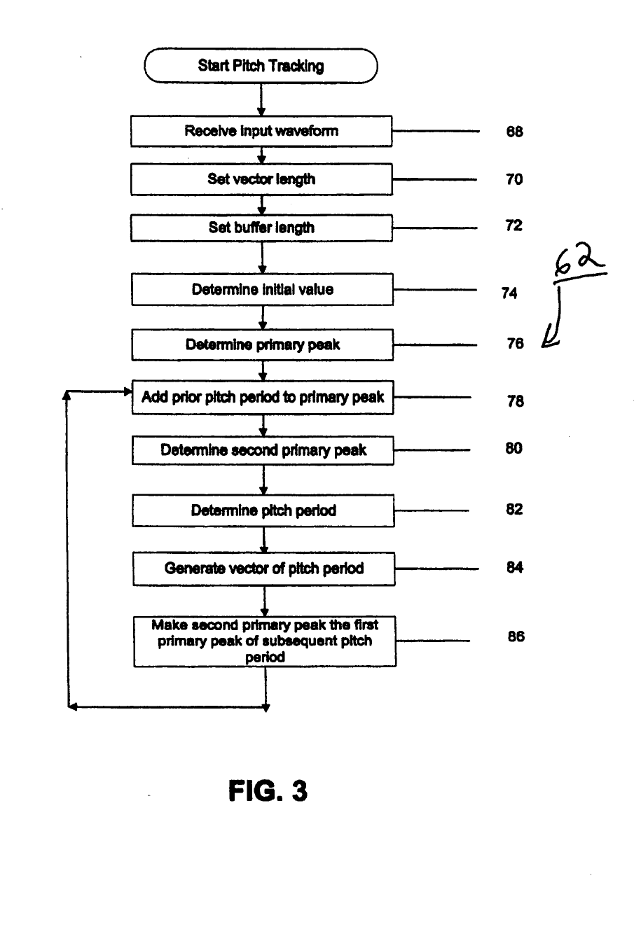

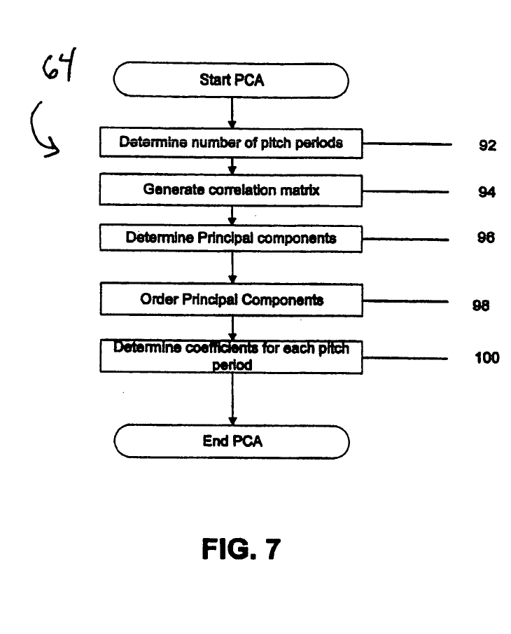

Referring to FIG. 2, speech recognition system 10 includes a process 60 to convert a input waveform, a “speech signal” into a different representation of the speech signal. Process 60 receives (61) the speech signal, as a waveform that corresponds to spoken speech. From the speech signal, process 60 determines (62) the pitch period of the speech signal using a pitch tracking process 62 (FIG. 3). Process 60 generates (64) principal components using a principal components process 64 (FIG. 7). Process 60 determines (64) if the principal components determined in (64) are similar to principal components stored in principal components storage 20. The principal components of a speaker's speech are compared to a collection of principal components in principal components storage 20. The received principal components are matched to the closest range of stored principal components. In one embodiments, the matching processes uses a least-squares process to determine the closest match.

Process 60 sends (66) a signal based on the comparison. The signal may be a phoneme (unit of speech sound). The closest match found triggers the output of the associated phoneme. The signal may also be an indication that a voice was recognized by system 10 as belonging to an individual whose principal components are stored in principal components storage 20. The signal may also be an instruction to execute another process (e.g., unlock a door, turn-on a light, grant access to a secure device, and so forth).

In one embodiment, the phonemes are sent to the text generator (not shown) that outputs text based on the phonemes received. The phoneme is represented by an array that includes a series of letters. For example, an “F” phoneme would be represented by the letters “F”, “PH”, and “GH”. The letters that are chosen depends on context. For instance, the phonemes for other parts of a word are considered.

In exemplary processes for storing principal components in principal component storage 20 and/or determining principal components from received speech, the pitch periods are determined and the principal components are determined based on the pitch periods as described in the following:

A. Pitch Tracking

Process 60 is one example of an implementation to use principal component analysis (PCA) to determine trends in the slight changes that modify a waveform across its pitch periods including quasi-periodic waveforms like speech signals. In order to analyze the changes that occur from one pitch period to the next, a waveform is divided into its pitch periods using pitch tracking process 62.

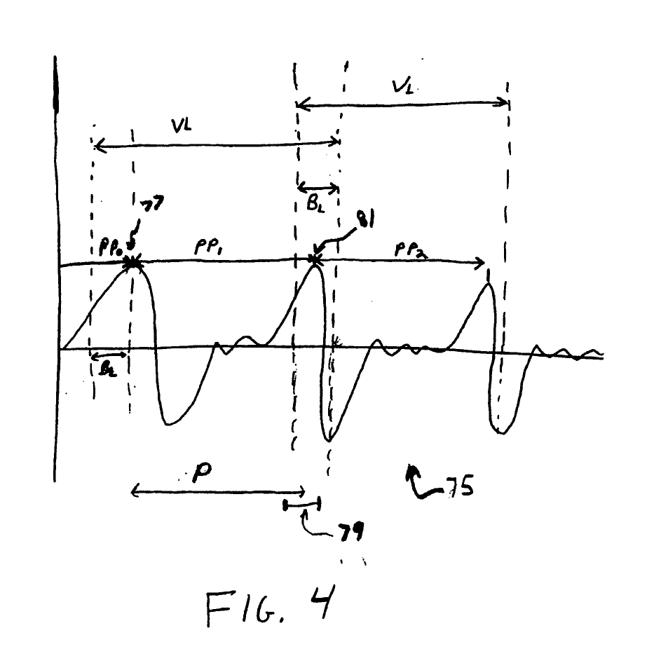

Referring to FIGS. 3 and 4, pitch tracking process 62 receives (68) an input waveform 75 to determine the pitch periods. Even though the waveforms of human speech are quasi-periodic, human speech still has a pattern that repeats for the duration of the input waveform 75. However, each iteration of the pattern, or “pitch period” (e.g., PP₁) varies slightly from its adjacent pitch periods, e.g., PP₀ and PP₂. Thus, the waveforms of the pitch periods are similar, but not identical, thus making the time duration for each pitch period unique.

Since the pitch periods in a waveform vary in time duration, the number of sampling points in each pitch period generally differs and thus the number of dimensions required for each vectorized pitch period also differs. To adjust for this inconsistency, pitch tracking process 62 designates (70) a standard vector (time) length, V_{L}. After pitch tracking process 62 is executing, the pitch tracking process chooses a vector length to be the average pitch period length plus a constant, for example, 40 sampling points. This allows for an average buffer of 20 sampling points on either side of a vector. The result is that all vectors are of a uniform length and can be considered members of the same vector space. Thus, vectors are returned where each vector has the same length and each vector includes a pitch period.

Pitch tracking process 62 also designates (72) a buffer (time) length, B_{L}, which serves as an offset and allows the vectors of those pitch periods that are shorter than the vector length to run over and include sampling points from the next pitch period. As a result, each vector returned has a buffer region of extra information at the end. This larger sample window allows for more accurate principal component calculations, but also requires a greater bandwidth for transmission. In the interest of maximum bandwidth reduction, the buffer length may be kept to between 10 and 20 sampling points (vector elements) beyond the length of the longest pitch period in the waveform.

At 8 kHz, a vector length that includes 120 sample points and an offset that includes 20 sampling units can provide optimum results.

Pitch tracking process 62 relies on the knowledge of the prior period duration, and need not determine the duration of the first period in a sample directly. Therefore, pitch tracking process 62 determines (74) an initial period length value by finding a “real cepstrum” of the first few pitch periods of the speech signal to determine the frequency of the signal. A “cepstrum” is an anagram of the word “spectrum” and is a mathematical function that is the inverse Fourier transform of the logarithm of the power spectrum of a signal. The cepstrum method is a standard method for estimating the fundamental frequency (and therefore period length) of a signal with fluctuating pitch.

A pitch period can begin at any point along a waveform, provided it ends at a corresponding point. Pitch tracking process 62 considers the starting point of each pitch period to be the primary peak or highest peak of the pitch period.

Pitch tracking process 62 determines (76) the first primary peak 77. Pitch tracking process 62 determines a single peak by taking the input waveform, sampling the input waveform, taking the slope between each sample point and taking the point sampling point closest to zero. Pitch tracking process 62 searches several peaks and takes the peak with the largest magnitude as the primary peak 77. Pitch tracking process 62 adds (78) the prior pitch period to the primary peak. Pitch tracking process 62 determines (80) a second primary peak 81 locating a maximum peak from a series of peaks 79 centered a time period, P, (equal to the prior pitch period, PP₀) from the first primary peak 77. The peak whose time duration from the primary peak 77 is closest to the time duration of the prior pitch period PP₀ is determined to be the ending point of that period (PP₁) and the starting point of the next (PP₁). The second primary peak is determined by analyzing three peaks before or three peaks after the prior pitch period from the primary peak and designating the largest peak of those peaks as the second peak.

Process 60 vectorizes (84) the pitch period. Performing pitch tracking process 62 recursively, pitch tracking process 62 returns a set of vectors; each set corresponding to a vectorized pitch period of the waveform. A pitch period is vectorized by sampling the waveform over that period, and assigning the ith sample value to the ith coordinate of a vector in Euclidean n-dimensional space, denoted by [symbol] ⁿ, where the index i runs from 1 to n, the number of samples per period. Each of these vectors is considered a point in the space [symbol] ⁿ.

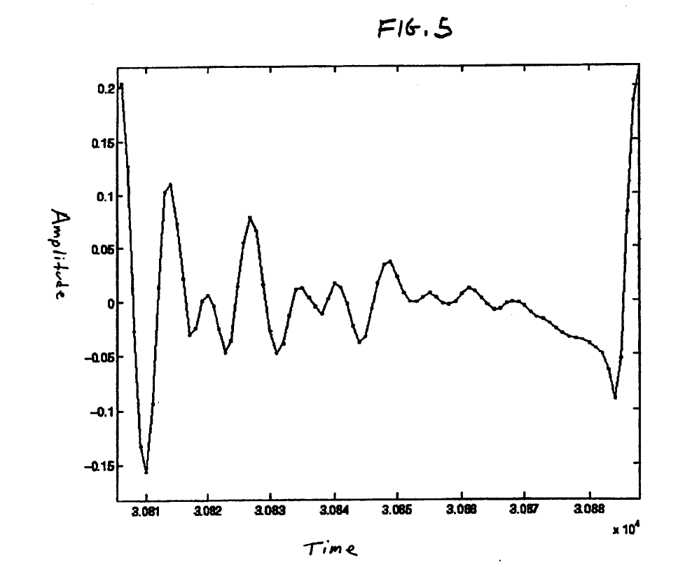

FIG. 5 shows an illustrative sampled waveform of a pitch period. The pitch period includes 82 sampling points (denoted by the dots lying on the waveform) and thus when the pitch period is vectorized, the pitch period can be represented as a single point in an 82-dimensional space.

Pitch tracking process 62 designates (86) the second primary peak as the first primary peak of the subsequent pitch period and reiterates (78)-(86).

Thus, pitch tracking process 62 identifies the beginning point and ending point of each pitch period. Pitch tracking process 62 also accounts for the variation of time between pitch periods. This temporal variance occurs over relatively long periods of time and thus there are no radical changes in pitch period length from one pitch period to the next. This allows pitch tracking process 62 to operate recursively, using the length of the prior period as an input to determine the duration of the next.

Pitch tracking process 62 can be stated as the following recursive function:

$$f ( {p}_{prev} , {p}_{new} ) = \{ \begin{matrix}f ( {p}_{new} , {p}_{next} ) : \vert s - d ( {p}_{new} , {p}_{0} ) \vert \leq \vert s - d ( {p}_{prev} , {p}_{0} ) \vert \\ d ( {p}_{prev} , {p}_{0} ) : \vert s - d ( {p}_{new} , {p}_{0} ) \vert > \vert s - d ( {p}_{prev} , {p}_{0} ) \vert\end{matrix}$$

The function f(p,p′) operates on pairs of consecutive peaks p and p′ in a waveform, recurring to its previous value (the duration of the previous pitch period) until it finds the peak whose location in the waveform corresponds best to that of the first peak in the waveform. This peak becomes the first peak in the next pitch period. In the notation used here, the letter p subscripted, respectively, by “prev,” “new,” “next” and “0,” denote the previous, the current peak being examined, the next peak being examined, and the first peak in the pitch period respectively. s denotes the time duration of the prior pitch period, and d(p,p′) denotes the duration between the peaks p and p′.

A representative example of program code (i.e., machine-executable instructions) to implement process 62 is the following code using MATHLAB:

function [a, t] = pitch(infile, peakarray)
% PITCH2 separate pitch-periods.
% PITCH2(infile, peakarray) infile is an array of a .wav
% file generally read using the wavread( ) function.
% peakarray is an array of the vectorized pitch periods of
% infile.
wave = wavread(infile);
siz = size(wave);
n = 0;
t = [0 0];
a = [ ];
w = 1;
count = size(peakarray);

| | |
|---|---|
| length = 120; | % set vector |
| offset = 20; | % length |
| while wave(peakarray(w)) > wave(peakarray(w+1)) | % find primary |
| w = w+1; | % peak |
| end | |
| left = peakarray(w+1); | % take real |
| y = rceps(wave); | % cepstrum of |
| x = 50; | % waveform |
| while y(x) ˜= max(y(50:125)) | |
| x = x+1; | |
| end | |

| | |
|---|---|
| prior = x; | % find pitch period length |
| period = zeros(1,length); | % estimate |
| for x = (w+1):count(1,2)−1 | % pitch tracking |
| right = peakarray(x+1); | % method |
| trail = peakarray(x); | |

```
  if (abs(prior-(right−left))>abs(prior-(trail−left)))
  n = n + 1;
  d = left−offset;
  if (d+length) < siz(1)
    t(n,:) = [offset, (offset+(trail−left))];
    for y = 1:length
    if (y+d−1) > 0
    period(y) = wave(y+d−1);
  end
end
```

| | |
|---|---|
| a(n,:) = period; | % generate vector |
| prior = trail−left; | % of pitch period |
| left = trail; | |
| end | |

Of course, other code (or even hardware) may be used to implement pitch tracking process 62.

B. Principal Component Analysis

Principal component analysis is a method of calculating an orthogonal basis for a given set of data points that defines a space in which any variations in the data are completely uncorrelated. The symbol, “ [symbol] ⁿ” is defined by a set of n coordinate axes, each describing a dimension or a potential for variation in the data. Thus, n coordinates are required to describe the position of any point. Each coordinate is a scaling coefficient along the corresponding axis, indicating the amount of variation along that axis that the point possesses. An advantage of PCA is that a trend appearing to span multiple dimensions in [symbol] ⁿ can be decomposed into its “principal components,” i.e., the set of eigen-axes that most naturally describe the underlying data. By implementing PCA, it is possible to effectively reduce the number of dimensions. Thus, the total amount of information required to describe a data set is reduced by using a single axis to express several correlated variations.

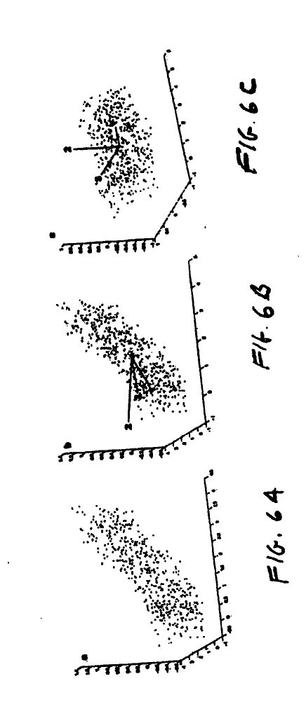

For example, FIG. 6A shows a graph of data points in 3-dimensions. The data in FIG. 6B are grouped together forming trends. FIG. 6B shows the principal components of the data in FIG. 6A. FIG. 6C shows the data redrawn in the space determined by the orthogonal principal components. There is no visible trend in the data in FIG. 6C as opposed to FIGS. 6A and 6B. In this example, the dimensionality of the data was not reduced because of the low-dimensionality of the original data. For data in higher dimensions, removing the trends in the data reduces the data's dimensionality by a factor of between 20 and 30 in routine speech applications. Thus, the purpose of using PCA in this method of speech recognition is to describe the trends in the pitch-periods and to reduce the amount of data required to describe speech waveforms.

Referring to FIG. 7, principal components process 64 determines (92) the number of pitch periods generated from pitch tracking process 62. Principal components process 64 generates (94) a correlation matrix.

The actual computation of the principal components of a waveform is a well-defined mathematical operation, and can be understood as follows. Given two vectors x and y, xy^{T} is the square matrix obtained by multiplying x by the transpose of y. Each entry [xy^{T}]_{i,j} is the product of the coordinates xᵢ and yⱼ. Similarly, if X and Y are matrices whose rows are the vectors xᵢ and yⱼ, respectively, the square matrix XY^{T} is a sum of matrices of the form [xy^{T}]_{i,j}:

$${XY}^{T} = {\sum }_{i , j}^{} {x}_{i} {y}_{j}^{T} .$$

XY^{T} can therefore be interpreted as an array of correlation values between the entries in the sets of vectors arranged in X and Y. So when X=Y, XX^{T} is an “autocorrelation matrix,” in which each entry [XX^{T}]_{i,j} gives the average correlation (a measure of similarity) between the vectors xᵢ and xⱼ. The eigenvectors of this matrix therefore define a set of axes in [symbol] ⁿ corresponding to the correlations between the vectors in X. The eigen-basis is the most natural basis in which to represent the data, because its orthogonality implies that coordinates along different axes are uncorrelated, and therefore represent variation of different characteristics in the underlying data.

Principal components process 64 determines (96) the principal components from the eigenvalue associated with each eigenvector. Each eigenvalue measures the relative importance of the different characteristics in the underlying data. Process 64 sorts (98) the eigenvectors in order of decreasing eigenvalue, in order to select the several most important eigen-axes or “principal components” of the data.

Principal components process 64 determines (100) the coefficients for each pitch period. The coordinates of each pitch period in the new space are defined by the principal components. These coordinates correspond to a projection of each pitch period onto the principal components. Intuitively, any pitch period can be described by scaling each principal component axis by the corresponding coefficient for the given pitch period, followed by performing a summation of these scaled vectors. Mathematically, the projections of each vectorized pitch period onto the principal components are obtained by vector inner products:

$${x}^{′} = {\sum }_{i = 1}^{n} ( {e}_{i} \cdot x ) {e}_{i} .$$

In this notation, the vectors x and x′ denote a vectorized pitch period in its initial and PCA representations, respectively. The vectors eᵢ are the ith principal components, and the inner product eᵢ·x is the scaling factor associated with the ith principal component.

In the present case, the principal components are the eigenvectors of the matrix SS^{T}, where the ith row of the matrix S is the vectorized ith pitch period in a waveform. Usually the first 5 percent of the principal components can be used to reconstruct the data and provide greater than 97 percent accuracy. This is a general property of quasi-periodic data. Thus, the present method can be used to find patterns that underlie quasi-periodic data, while providing a concise technique to represent such data. By using a single principal component to express correlated variations in the data, the dimensionality of the pitch periods is greatly reduced. Because of the patterns that underlie the quasi-periodicity, the number of orthogonal vectors required to closely approximate any waveform is much smaller than is apparently necessary to record the waveform verbatim.

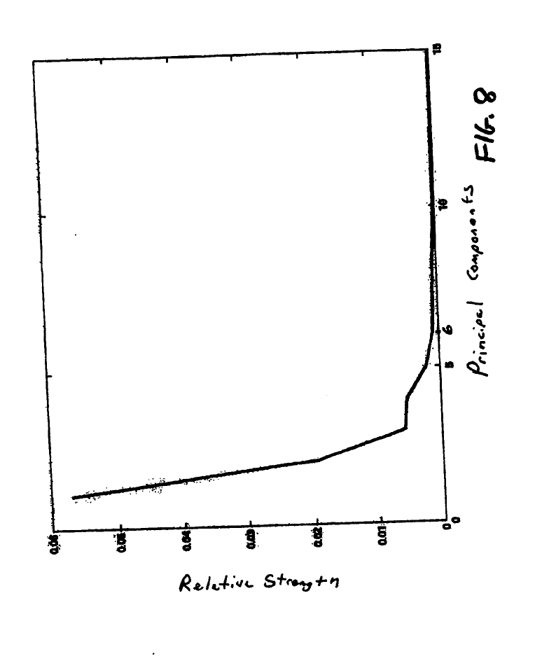

FIG. 8 shows an eigenspectrum for the principal components of the ‘aw’ phoneme. The eigenspectrum displays the relative importance of each principal component in the ‘aw’ phoneme. Here only the first 15 principal components are displayed. The steep falloff occurs far to the left on the horizontal axis. This indicates the importance of later principal components is minimal. Thus, using between 5 and 10 principal components would allow reconstruction of more than 95% of the original input signal. The optimum tradeoff between accuracy and number of bits transmitted typically requires six principal components. Thus, the eigenspectrum is a useful tool in determining how many principal components are required for the speech recognition of a given phoneme (speech sound).

A representative example of program code (i.e., machine-executable instructions) to implement principal components process 64 is the following code using MATHLAB:

| function [v,c] = pca(periodarray, Nvect) | |
|---|---|
| % PCA principal component analysis | |
| % pca(periodarray) performs principal component analysis on an | |
| % array where each row is an observation (pitch-period) and | |
| % each column a variable. | |
| n = size(periodarray); | % find # of pitch periods |
| n = n(1); | |
| l = size(periodarray(1,:)); | |
| v = zeros(Nvect, 1(2)); | |
| c = zeros(Nvect, n); | |
| e = cov(periodarray); | % generate correlation matrix |
| [vects, d] = eig(e); | % compute principal components |
| vals = diag(d); | |
| for x = 1:Nvect | % order principal components |
| y = 1; | |

| while vals(y) ˜= max(vals); | |
|---|---|
| y = y + 1; | |
| end | |
| vals(y) = −1; | |
| v(x,:) = vects(:,y)’; | % compute coefficients for |
| for z = 1:n | % each period |

```
    c(x,z) = dot(v(x,:), periodarray(z,:));
  end
end
```

Of course, other code (or even hardware) may be used to implement principal components process 64.

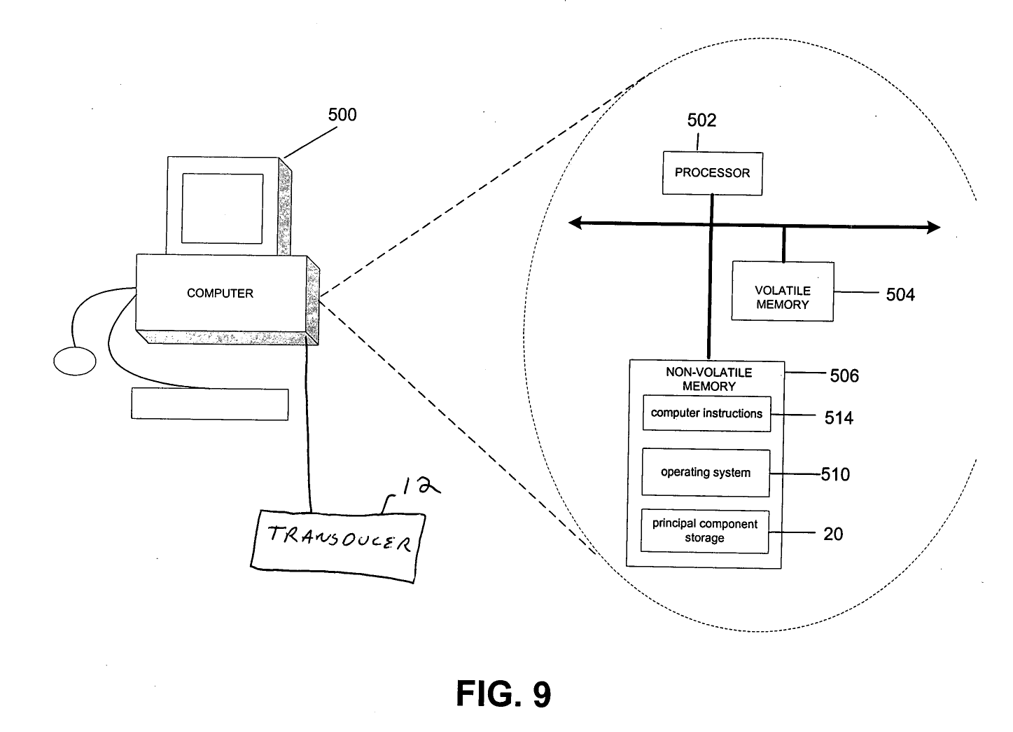

FIG. 9 shows a computer 500 for speech recognition using process 60. Computer 500 includes a processor 502, a volatile memory 504, a non-volatile 506 (e.g., read only memory, flash memory, disk etc.), and a transducer 12 to receive speech. The computer can be a general purpose or special purpose computer, e.g., controller, digital signal processor, etc. Non-volatile storage 506 stores operating system 510, principal component storage 20 for speech recognition, and computer instructions 514 which are executed by processor 502 out of volatile memory 504 to perform process 60.

Process 60 is not limited to use with the hardware and software of FIG. 9; it may find applicability in any computing or processing environment and with any type of machine that is capable of running a computer program. Process 60 may be implemented in hardware, software, or a combination of the two. For example, process 60 may be implemented in a circuit that includes one or a combination of a processor, a memory, programmable logic and logic gates. Process 60 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 60 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 60. Process 60 may also be implemented as a machine-readable storage medium, configured with a computer program, where upon execution, instructions in the computer program cause the computer to operate in accordance with process 60.

The processes are not limited to the specific embodiments described herein. For example, the processes are not limited to the specific processing order of FIGS. 2, 3 and 7. Rather, the blocks of FIGS. 2, 3 and 7 may be re-ordered, as necessary, to achieve the results set forth above.

Other embodiments not described herein are also within the scope of the following claims.

1. A method of speech recognition, comprising:
determining principal components of received speech over a series of pitch periods; and
comparing the principal components of the received speech to stored principal components to find a set of the stored principal components having a specified degree of similarity to the determined principal components of the received speech.

2. The method of claim 1, further comprising:
determining the pitch periods of the received speech.

3. The method of claim 1, further comprising:
sending a signal based on comparing the principal components of the received speech to stored principal components.

4. The method of claim 3, wherein sending a signal comprises:
accessing a database that stores phonemes; and
sending a phoneme.

5. The method of claim 4, further comprising:
converting the phoneme to text.

6. An apparatus comprising:
a memory that stores executable instructions for speech recognition; and
a processor that executes the instructions to:
determine principal components of received speech over a series of pitch periods; and
compare the principal components of the received speech to stored principal components to find a set of the stored principal components having a specified degree of similarity to the determined principal components of the received speech.

7. The apparatus of claim 6, further comprising executable instructions to:
determine the pitch periods of the received speech.

8. The apparatus of claim 6, further comprising executable instructions to:
send a signal based on comparing the principal components of the received speech to stored principal components.

9. The apparatus of claim 8, wherein executable instructions to send a signal comprises executable instructions to:
access a database that stores phonemes; and
send a phoneme.

10. The apparatus of claim 9, further comprising executable instructions convert the phoneme to text.

11. An article comprising a machine-readable medium that stores executable instructions for speech recognition, the instructions causing a machine to:
determine principal components of received speech over a series of pitch periods; and
compare the principal components of the received speech to stored principal components to find a set of the stored principal components having a specified degree of similarity to the determined principal components of the received speech.

12. The article of claim 11, further comprising instructions causing a machine to:
determine the pitch periods of the received speech.

13. The article of claim 11, further comprising instructions causing a machine to:
send a signal based on comparing the principal components of the received speech to stored principal components.

14. The article of claim 13, wherein instructions causing a machine to send a signal comprises instructions causing a machine to:
access a database that stores phonemes; and
send a phoneme.

15. The article of claim 14, further comprising instructions causing a machine to:
converting the phoneme to text.
